(19) United States
(12) Patent Application Publication
(10) Pub. No.: US 2009/0066486 A1
(43) Pub. Date: Mar. 12, 2009

(54) MODULAR SIGNAL DEVICE FOR A ROOM OCCUPANCY MANAGEMENT SYSTEM AND A METHOD FOR USING SAME

(75) Inventors: James P. Kiekbusch, Winona, MN (US); Philip O'Keefe, Winona, MN (US); Chad Brandes, Winona, MN (US); Kevin Keeffe, LaCrosse, WI (US); Timothy Skwiot, Winona, MN (US)

Correspondence Address: MICHAEL P. MAZZA, LLC, 686 CRESCENT BLVD., GLEN ELYN, IL, 60137, US

(73) Assignee: OMNI CONTROL SYSTEMS, INC., Winona, WI (US)

(21) Appl. No.: 11/853,167

(22) Filed: Sep. 11, 2007

(51) Int. Cl. G08B 5/36

(52) U.S. Cl. 340/286.02; 340/815.45

(57) ABSTRACT

A method and a system for using a modular signal device for a room occupancy management system are disclosed here. The method includes the steps of determining the occupancy status of a room associated with the device and generating a signal in the device in response to the determination of the status of the room. The device may be a light bar displaying different color patterns in response to the occupancy status of the room. A room occupancy management system is also disclosed. The system includes a signal device for generating a signal displaying the occupancy status of an associated room and a control unit for controlling the device.

### BACKGROUND OF THE INVENTION

The present invention relates to a method for using a modular signal device for a room occupancy management system, and a room occupancy management system employable in various settings, such as a health care setting. The device and system enable healthcare personnel, for example, to assign patients to examination rooms and to monitor the status of the examination rooms.

Hospitals and healthcare professionals compete to improve the quality of their services. The management of room occupancy can be improved. For example, when a patient is placed in an exam room, caregivers and staff may not have immediate access to information about the status of the patient, whether or not a physician has visited the patient, when the visit happened, etc.

Several prior art color-coded signal systems have been devised to provide a visually-cued room occupancy management system. For example, one color-coded signal device consists of a series of multi-colored plastic flags mountable on the outside door of the examination room. Each colored flag is a code for the status of the room. When all the flags are lowered against the wall, the room is clean and empty. A raised white flag indicates that the patient is assigned to the room and is waiting inside. Raised white and yellow flags indicate that the physician is seeing the patient. A raised green flag indicates that the patient has left the room and it is ready for cleanup and so forth.

There are several problems with this kind of signal device. It is passive and has no internal lighting, so it is not visible in dimly lit hallways over long distances, or around corners. Additionally, it is not capable of visually alerting hospital personnel outside the room to emergency situations. It is also not capable of keeping track of the amount of time that the patient stays in a room or how much time a caregiver stays in the room.

Another prior art color-coded signal device consists of a vertical light fixture mounted on the wall outside an examination room. The light fixture is a light bar that has a matrix of single-color light emitting diodes (LEDs) soldered to a printed circuit board. Although this device provides more visibility than plastic flags, there are several problems associated with it. The color of each LED is fixed because it is soldered to a printed circuit board. Furthermore, the color bands and brightness of the fixed LEDs vary significantly from one manufacture to another. The LEDs are manufactured in limited number of colors, and each matrix may be made of forty fixed-colors LEDs. The manufacture of these LEDs is a relatively costly and expensive process. Another problem with these LEDs is that the matrix creates small and concentrated zones of light known as “hot spots” as a result of having uneven color intensity across the light bar. Hot spots cause confusion as to the identity of colors and thereby frustrate the purpose of the signal device.

Accordingly, it would be advantageous to provide a method for using a signal device for a room occupancy management system that includes one or more of the following advantageous features, such as an internally-lit signal device; a signal device capable of utilizing a wide variety of colors; a signal device that provides a relatively even color intensity; a signal device that does not use a fixed LED matrix; a signal device that enables a user to manage examination of patients efficiently and a signal device that enables caregivers and health staff to monitor the status of the patients in real time. Other advantages of the present invention will be apparent from the foregoing description.

### Definition of Claim Terms

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Uniform Brightness” means substantially uniform lumen intensity measured in millicandela (mcd).
“Hot Spots” means lack of uniform brightness across a panel or a light bar.
“Bleeding of color bands” means color bands crossing into adjacent color bands of the light bar.

### SUMMARY OF THE INVENTION

The objects mentioned above, as well as other objects, are solved by the present invention, which overcomes disadvantages of prior art system, while providing new advantages not believed associated with such systems.

The invention relates to a method for using a modular signal device for a room occupancy management system (ROMS™). The method includes the steps of determining the status of a room and generating a signal in the modular device in response to the determination of the status of the room. The modular device may be a light bar that may be divided into segments. Each segment may have one or more LEDs to generate color bands that have uniform brightness. The segments may also include light transmissive materials to diffuse and spread the color bands evenly across the material and to generate an even color band in each segment. Each segment may be separated from other segments by a divider to prevent the color band in each segment from bleeding into others. The method may also include the step of remotely controlling the LEDs by remote display and control units using a local area network (LAN). The method may also include the step of controlling the LEDs by a local keypad.

The invention also relates to a room occupancy management system, which may be used in various settings such as healthcare setting. According to a preferred embodiment of the present invention, the system may include a modular signal device that may be located outside an examination room. The device may include a light bar divided into a plurality of segments, and each segment may include one or more light emitting diodes (LEDs) for generating color bands that has uniform brightness. The color bands may indicate the status of examination of a patient in the examination room. The light bar may include a reader for reading a radio frequency identification tag of a caregiver and so forth.

The LEDs may be controlled by one or several remote display and control units. The remote display and control units may communicate with the LEDs via a (LAN). The remote display and control units may be located at a nurses' station, a health administration station, other PCs and so forth. The remote display and control units may display the colors of the light bars located outside the examination rooms to indicate the status of examination of the patients. The remote display and control units may also receive the data transmitted from the RFID reader to indicate whether any caregiver has examined the patients and the waiting time for each patient.

The LEDs may also be controlled by one or several external control units, such as keypads that have buttons coordinated with the color bands of the light bar. The keypads may be located outside the examination rooms and may operate independently of the LAN.

In an embodiment of the invention, the light bar may have an internet protocol (IP) address. The IP address may be configured to indicate the physical location of the light bar in a health institution. For example, the IP address may include four octets, the first octet is configured to identify the LAN that the light bar is connected to, the second octet is configured to identify the institution building floor number, the third octet is configured to identify the wing number of the floor and the fourth octet is configured to identify the patient's room number. The light bar may also have a media access control (MAC) address.

In an embodiment, the signal device may be controlled by a remote display and control unit. The remote display and control unit may communicate with a server via a first LAN. The server may communicate with a firmware of the signal device via a second LAN. The firmware may include a microcontroller and software, which may be permanently stored within the flash memory of the microcontroller. The firmware may be connected to an electrically erasable programmable read-only memory (EEPROM) chip for storing the IP and MAC addresses of the signal device and retrieving the IP and MAC addresses at startup operation of the signal device. The firmware may process commands received from the remote display and control unit over the LANs and may respond by changing a state of the signal device, such as color band. The server may periodically send an IP data stream to the firmware to determine the state of the signal device (polling). The firmware may respond by checking the state of the signal device and sending an IP data stream containing the state of the signal device data back to the server. The server may employ the IP data stream to update the data in the remote display and control unit.

The signal device may also be controlled by a local external control unit. The local control unit may be communicating with the firmware for controlling the state of the signal device by transmitting commands to the microcontroller to change the state of the signal device. The microcontroller may send an IP data stream to the server to update the state of the signal device.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings. The drawings illustrate currently preferred embodiments of the present invention. As further explained below, it will be understood that other embodiments, not shown in the drawings, also fall within the spirit and scope of the invention.

FIG. 1 is a schematic view showing architecture of a preferred embodiment according to the principles of the present invention;

FIG. 2 is a perspective view showing a group light bar display screen;

FIG. 3 is a perspective view showing an individual light bar control screen;

FIG. 4 is a perspective view showing light bar visibility control screen;

FIG. 5 is a block diagram of the light bar;

FIG. 6 is a block diagram of the keypad;

FIG. 7 is a schematic view showing architecture of an alternative embodiment;

FIG. 8 is a perspective view showing a preferred light bar with different color bands;

FIG. 9 shows the use of the light bar in a healthcare setting;

FIG. 10 is a sectional view through the light bar;

FIG. 11 is a front view showing a light transmissive material covering the light bar;

FIG. 12 is a back view of the inside surface of the light transmissive material;

FIG. 13 is an enlarged view of the LEDs shown in FIG. 11; and

FIG. 14 is a perspective view showing a keypad control unit.

### DETAILED DESCRIPTION OF THE PREFERRED EMBODIMENTS

Set forth below is a description of what are currently believed to be the preferred embodiments and/or best examples of the invention claimed. Future and present alternatives and modifications to these preferred embodiments are contemplated. Any alternatives or modifications which make insubstantial changes in function, in purpose, in structure or in result are intended to be covered by the claims of this patent.

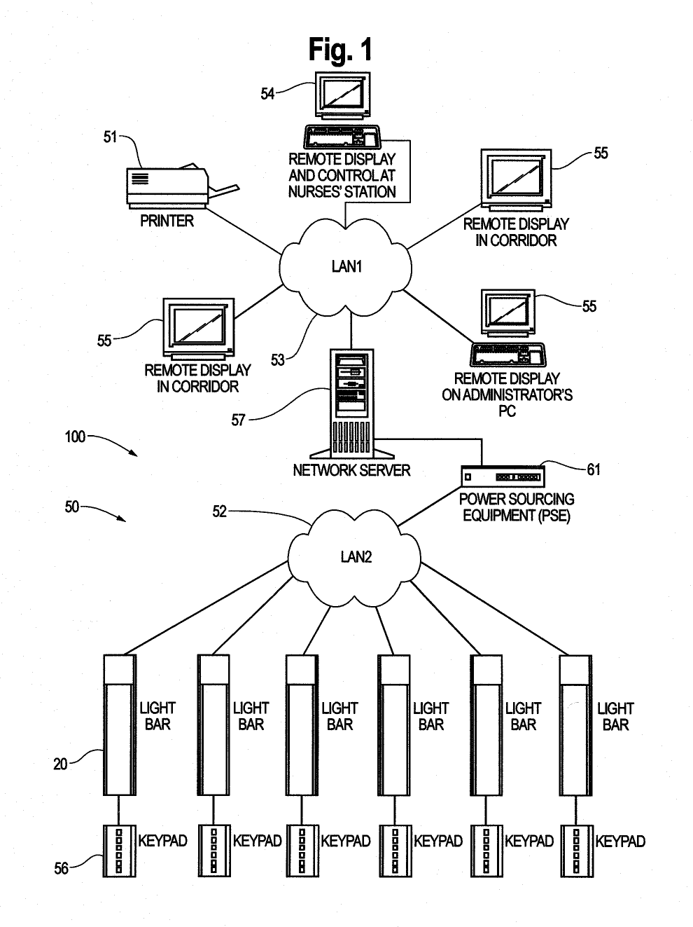

Referring now to FIG. 1, the architecture of a room occupancy management system 100 according to a preferred embodiment of the present invention is shown. System 100 employs a modular signal device 10 such as light bar 20. System 100 may include a local area network (LAN), such as LAN 52 that may be associated with light bars 20 and the keypads 56. System 100 may also employ another LAN 53 that may be associated with the remote displays 55 and control stations 54. Both LANs 52 and 53 may be controlled by a common network server 57. The architecture of system 100 and the design of light bars 20 may enable each light bar 20 to be manually controlled by keypads 56 even if LANs 52 and 53 fail and power is still available. In a healthcare setting, the present invention may enable remote control and monitoring of light bars 20 from remote display and control stations 54 located at a nurses' station or from an administrative PC via LAN 53 on network server 57.

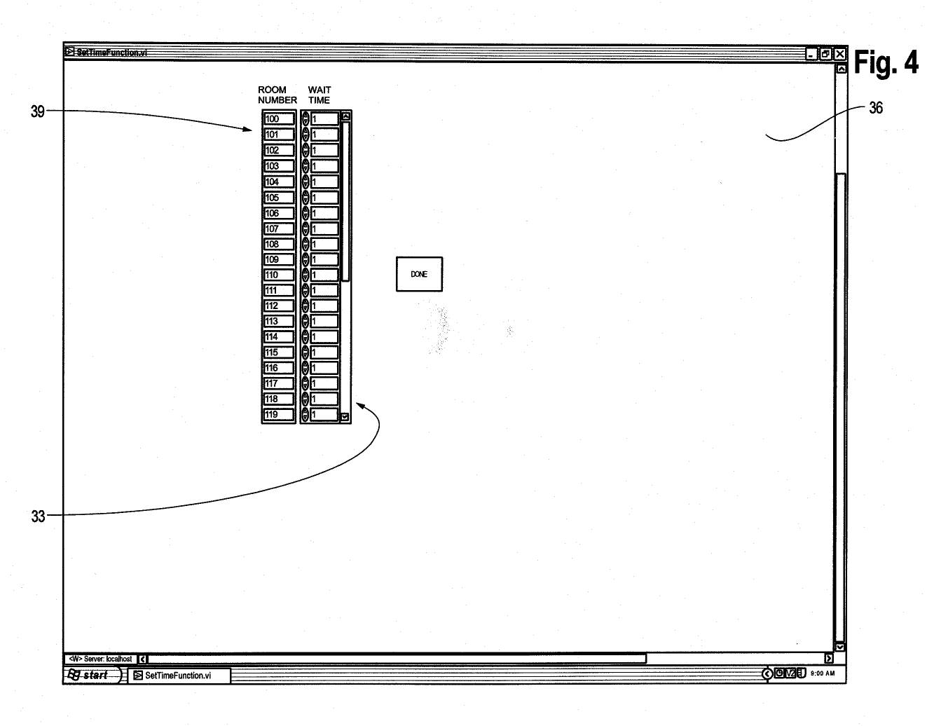

Referring now to FIG. 1 and FIG. 1A, each light bar 20 preferably includes a printed circuit board (PCB) that may receive a firmware 18, which may include a microcontroller chip, such as microcontroller 46 shown in FIG. 5, and software that may be permanently stored within the flash memory on the chip. The brightness and the color of each color band on light bar 20 may be changed by updating the firmware in light bar 20. Firmware 18 has several functions. It creates a transmission control protocol/internet protocol (TCP/IP) server and passively waits for a connection from PCs 54 and 55. Firmware 18 may also process commands received from PCs 54 and 55 over LAN 53 and respond by changing the state of the selected color band of light bar 20. Firmware 18 may also process data contained within the IP data stream received from clients 54 and 55 for color band status. Firmware 18 may check the status of each color band on light bar 20 and may direct microcontroller 46 to send an IP data stream containing color band status data back to server 57. Additionally, the firmware may process data received from local keypad 56 to control color bands locally.

Each light bar PCB may be assigned unique Media Access Control (MAC) and Internet Protocol (IP) addresses. The IP address enables unique identification of any particular light bar 20 on LANs 52 and 53. The IP address typically consists of four bytes and each byte contains eight bits. The bytes are also known as octets. The IP addresses are usually shown in dotted decimals by placing a period between each of the four octets. For example, the IP address “0000101010000000000000000000” is written in dotted decimals as 10.0.0.1. Each octet ranges in value from a minimum of 0 to a maximum of 255. According to the present invention, in order to identify the IP address of a particular light bar 20 in a healthcare setting, the first octet may be used to identify the network that the light bar is connected to; the second octet may be used to identify the hospital building floor number; the third octet may be used to identify the wing number of the floor and the fourth octet may be used to identify the examination room associated with light bar 20. For example, a light bar 20 may have the IP address of “120.4.1.136.” The first octet “120” may identify the network that the light bar is connected to; the second octet “4” may identify the hospital building floor number; the third octet “1” may identify the wing number of the floor and the fourth octet “136” may identify the exam room number.

The MAC address is a six byte unique identifier and is also known as the hardware address or the physical address. Each network device may have its own unique MAC address, while the IP address changes if the network device moves from one network to another. MAC addresses are 12-digit hexadecimal numbers (48 bits in length). The first half of a MAC address contains the twenty four bit identification number of the network adapter manufacturer. This number is known as an organizationally unique identifier (OUI). The second half of a MAC address represents the serial number assigned to the adapter by the manufacturer. For example, if a device has a MAC address of “00:A0:C9:14:C8:29,” the prefix “00A0C9” may indicate the name of the network adapter's manufacturer.

The IP and MAC addresses may be stored in an external electrically erasable programmable read-only memory (EEPROM) chip 78, such as Microchip Technology 24AA01 also shown in FIG. 5. Chip 78 may communicate with microcontroller 46 in order to store and retrieve the color control settings of light bars 20. When light bar 20 is powered up, the firmware may retrieve the MAC and IP addresses from chip 78 in order to begin communicating over LANs 52 and 53.

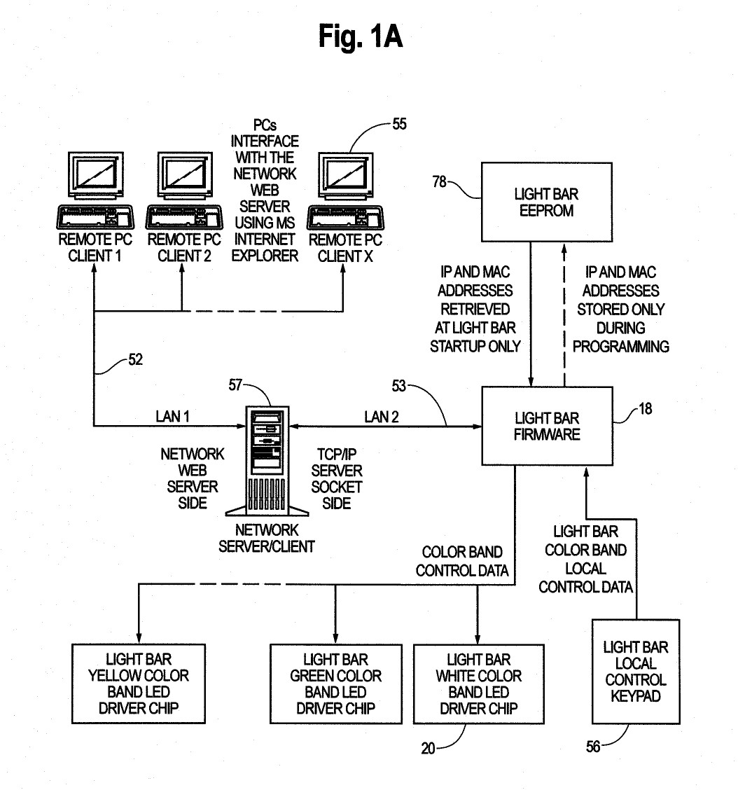

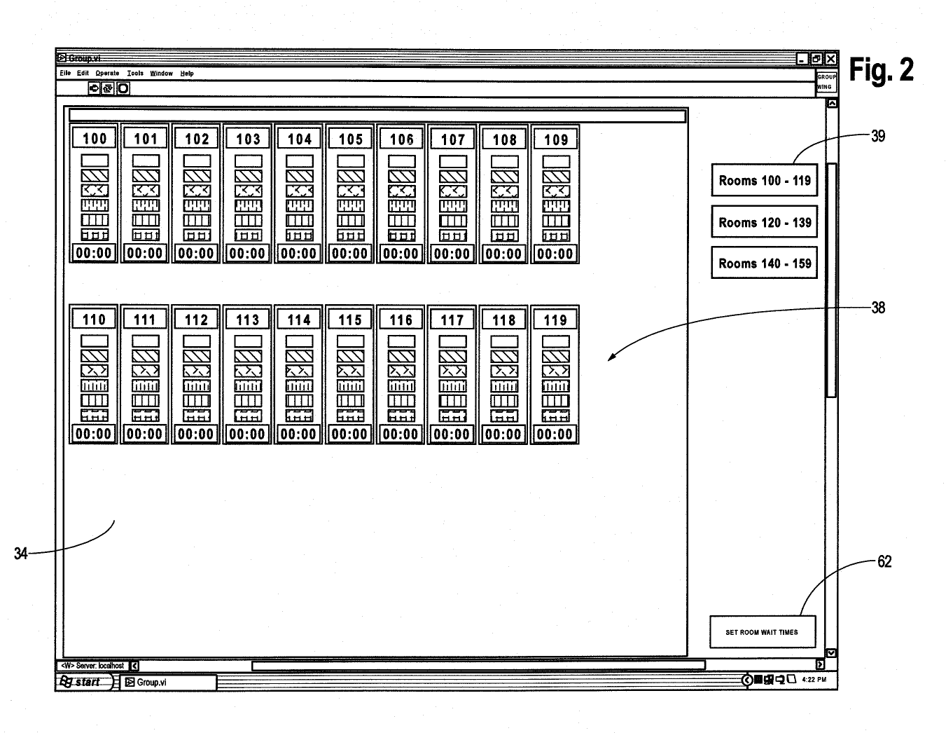

Remote display and control stations 54 and 55 may be equipped with two user interfaces, such as screens 34, shown in FIG. 2, which displays the status of the group of light bars 20 and screen 35, and which may display the status of a particular light bar 20 (FIG. 3). Each remote display 54 may be capable of displaying a simplified version of either screen 34 or 35.

Referring now to FIGS. 2-4, screen 34 shown in FIG. 2 illustrates the status of light bars 20 corresponding to examination rooms 100-119, as it might be displayed on remote display and control stations 54 and 55. Light bar icons 38 may show which color bands are lit on each light bar 20. Room numbers icons 39 may be shown at the top of each light bar icon 38. In FIG. 2, all six color bands may be lit on each light bar icon 38 depending on the status of occupancy in each room. For example, light bar 20 may display a yellow color to indicate that a physician is examining a patient in the room. Light bar 20 may display a red color to indicate a state of emergency in a particular room. Light bar 20 may also display a white color to indicate that the patient is waiting in the room. Light bar 20 may also display a blue color to indicate that a caregiver has checked the status of a patient but that the patient is still waiting for the examining physician. Light bar 20 may be programmed to display any single color or combination of colors in any situation. Icon 62 on screen 34 may display the waiting time for each patient in a particular room. Icon 62 may provide caregivers with the waiting time information of each patient in each room displayed on remote display and control stations 54 and 55.

Room number icons 39 may be positioned to the side to enable the user to view the light bar icons groups 38 associated with the corresponding rooms. A user may be able to view the status of each particular light bar 20 by clicking on the corresponding room number icons 39.

Referring now to FIG. 3, screen 35 may display the status of a particular light bar 20A in a particular room, such as room 109. Screen 35 may also display the waiting time for a patient in the corresponding room 109. Screen 35 enables resetting of a room status by clicking on set room wait times icon 62. A user may also click on icon 62 in order to set the maximum patient wait time. The wait time count may be started by activating a color band that signifies that the patient is in the room and waiting, such as a white color. When the maximum wait time is exceeded in the room, associated room icon 39 displaying the occupancy status of rooms 100-119 may receives a red background in order to prompt the user to click on the icon 39 to view particular light bar 20A in its alarm state. Light bar 20A corresponding to room 109 may receive a red background indicating an emergency situation. The user in remote display and control stations 54 and 55 may be prompted to dispatch a caregiver to the room to check on the patient. After checking on the patient, light bar 20A may display a blue background color to indicate that a nurse has checked the status of the patient but that the patient is still waiting for the examining physician. The dark blue color may be eliminated when a physician presses on keypad 56, which may be mounted on a corridor outside the patient's room in a hospital.

Still referring to FIG. 3, display screen 35 may also display “all lights off” icon 64 and “care giver in” icon 65 at a center of the screen. When the user clicks on icon 64, all color bands may be turned off on the associated light bars. When the user clicks on icon 65, one color band may be lit, for example yellow, in order to show that the physician is in the room.

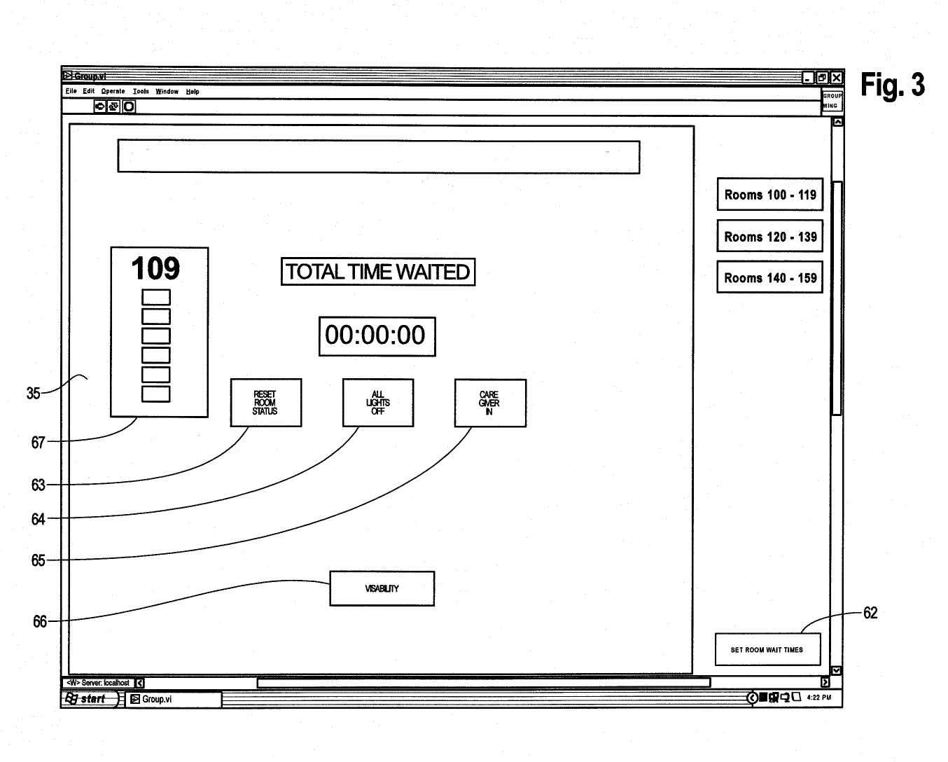

The visibility icon 66 enables a user to focus on the status of particular rooms. When a user clicks on icon 66, screen 36 may appear as shown in FIG. 4. Screen 36 may allow light bar icons 38 to be masked off of screen 34 in order to display the status of rooms 100-119 only.

Screen 36 may also display the waiting time icon 33 for each patient in each of the examination rooms, 100-119. Health staff and caregivers would thereby be provided with immediate access to the status of each patient in each examination room 100-119 via remote display and control stations 54 and 55, which may be located throughout the health institution.

Screens 34-36 may be similar to web pages that may be accessible by clients 54 and 55 through a web browser, such as Microsoft's Internet Explorer, in runtime environment via TCP/IP. For example, when a user at a remote display and control stations 54 located at a nurses' station decides to turn off a color band on light bar 20 down a hall, the user may click on the appropriate icon on screens 34-36. Remote display and control stations 54 located at a nurses' station, for example, may create an IP data stream on server 57 using the runtime environment. This data stream may be sent out on LAN 53. The IP data stream may contain a block of data that carries with it the information necessary to deliver it to the IP address of light bar 20.

The internet protocol (IP) may deliver the data stream by checking the destination address in the header, and comparing that information to an Address Resolution Protocol's (ARP) table. If the destination address of a particular light bar is on the same LAN that is connected to remote display and control station 54, then the packet is delivered directly to that light bar. When microprocessor 46 receives the data stream, it analyzes the data within and turns off/on the color band according to the user's command.

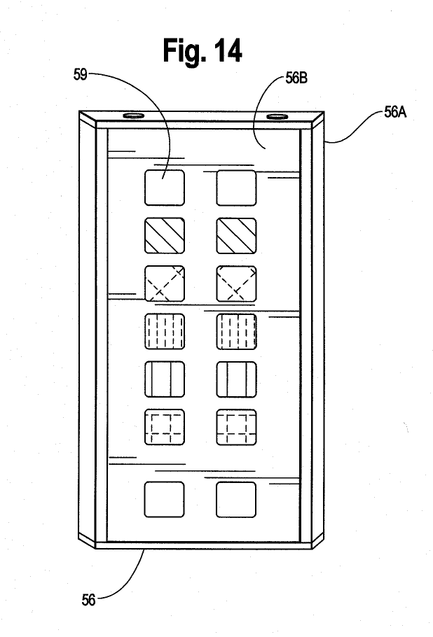

Server 57 may periodically communicate with all of light bars 20 on LAN 52 to determine their color band states, a process called “polling.” The communication may be accomplished by sending an IP data stream to each light bar 20. Light bars 20 may respond to server 57 with IP data streams containing color bar state information. Server 57 may use this information to update display and control screens 34-36 in the runtime environment. In this arrangement, when a caregiver presses buttons 59 of keypad 56 shown in FIG. 14, which may be located in a hallway below light bar 20 in a hospital, the keystroke may be communicated to microcontroller 46 on the PCB of light bar 20. Microcontroller 46 may turn on the associated color band on light bar 20 and then waits for server 57 to ask for an update for color band states until it sends out an IP data stream.

TCP may verify that data is delivered across LAN 52 accurately and in the proper sequence. TCP provide reliable service by ensuring that a data stream is resubmitted when transmission results in an error.

Information regarding color bands, patient's waiting time, alarm states and other information for each light bar may be stored in LAN server 57. The information may be stored in a comma separated variable (CVS) spreadsheet. A health administrator may access the data in order to manage room occupancy in a health care institution from any remote display and control station 54 or 55.

Referring now to FIG. 5, a block diagram of light bar 20 is shown. Power may be supplied to each light bar 20 and keypad 56 using power over the Ethernet (POE) 71. Because the system 100 is employing POE, only a single 8-conductor category 5 (CAT5) ethernet cable is needed for each light bar 20. The cable contains power and data conductors, which allows flexibility in locating light bars 20 and significantly decreases installation costs. POE 71 may be provided at 48 VDC from power sourcing equipment 61, shown in FIG. 1, over four conductors, +48 VDC on one twisted pair and −48 VDC on the other twisted pair. Power sourcing equipment 61 may automatically detect light bars 20 when they are connected to LAN 52 in order to supply power to these light bars. Data from LAN 52 may be transmitted over the remaining two twisted pairs of conductors. The ethernet cable may be connected to light bars 20 via an RJ-45 modulator connector 70. POE 72 may pass through a Schottky barrier diode bridge, not shown, and split in two branches 72 and 73. Branch 73 may pass the +48 VDC power directly to RGB LEDS 41 in each color band. Branch 72 may pass the +48 VDC/−48 VDC POE through various components including an LTC4267 POE interface and switching regulator 74, a POE 13P-50LB flyback transformer 75, and an LM2937 3.3 voltage regulator 76 for providing logic power. Flyback transformer 75 may store energy in its magnetic circuit and functions like a pure inductor to provide ripple filtering. Flyback transformer 75 may also provide voltage isolation between its input and output.

Each light bar 20 may contain a microcontroller 46, such as Freescale Semiconductor ColdFire MCF52233CAF60. Microcontroller 46 may communicate with network server 57 over LAN 52 via transmission control protocol/internet protocol (TCP/IP) in order to receive color band control commands of light bars 20 from remote display and control stations 54 and 55, and send color band on/off states and occupancy data for light bars 20 to remote display and control stations 54 and 55, and other PCs. Microcontroller 46 may send room occupancy data to server 57 for processing, storage, and report generation. Microcontroller 46 may receive color band control commands of light bar 20 from keypad 56 via an inter-integrated circuit (I2C) bus 86. Microcontroller 46 may communicate with an external electrically erasable programmable read-only memory (EEPROM) chip 78 in order to store and retrieve the color control settings of RGB LEDs 41. Microcontroller 46 may also communicate with LED driver chips 42, such as Texas Instruments TLC5923, via a serial port interface (SPI) to send color control signals. Microcontroller 46 may control LED driver chip 42 by varying the current flow through each of the three LED elements in RGB LED 41 in steps to vary the output intensity of each element and produce different colors by combining these intensities. TLC5923 has 16 output channels. Each channel has an on/off states and a 128-step adjustable constant current sink. According to one embodiment of the present invention, TLC5923 may have five channels tied together and connected to red RGB LED element, five output channels may be tied together and connected to the green RGB LED element, and five output channels may be tied together and connected to the blue RGB LED element.

The specific color settings used by microprocessor 46 to operate TLC5923 may be set by the user's specifications. The color settings may be stored in EEPROM chip 78 when microcontroller 46 is programmed during manufacturing.

As an alternative to programming via LAN 53, microcontroller 46 may be connected to a PC, via RS232 serial data port 80 or via a background debug module (BDM) interface 81 to facilitate troubleshooting and debugging of the software that runs microcontroller 46. A watchdog supervisor chip, not shown, such as Texas Instruments' TPS3828, may be connected to microcontroller 46 in order to prevent the microcontroller from locking up during the boot cycle.

Microcontroller 46 may communicate digitally with LED driver chip 42 in order to receive LED open detection (LOD) signals, which informs microcontroller 46 about broken or disconnected LEDs in light bar 20, and switch between serial communications modes.

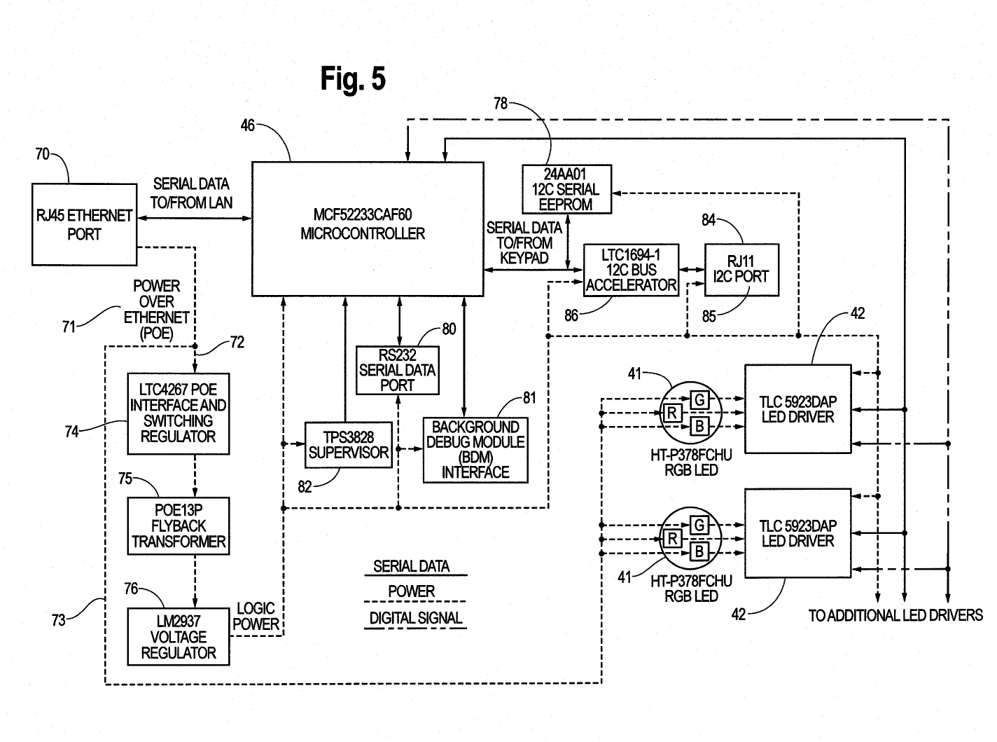

Referring now to FIG. 6, the printed circuit board (PCB) of keypad 56 may be connected with the PCB of light bar 20 via a six-conductor telephone cable using an RJ11-6 modular connector. Microcontroller 46 and keypad 56 may communicate via an I2C bus, which is a protocol available from Philips Semiconductors. On I2C bus, devices may be connected in parallel on the two wires and are classed as either “master” or “slave.” Preferably, microcontroller 46 housed within light bars 20 is the “master,” while all other devices are “slaves” including EEPROM chip 78, which contains non-volatile memory and is used to store the color band color settings of light bars 20, and the 12C I/O port 87. I2C I/O port 87 may interface with keypad buttons 59 to communicate over I2C bus with microcontroller 46 in order to enable microcontroller 46 to determine which buttons of keypad 56 the user pressed and control color bands of light bar 20 accordingly.

The user interface of keypad 56 may operate independently of LAN 52 as long as POE is present to provide power to light bars 20 and their associated keypads 56. As such, each light bar 20/keypad 56 may be installed to be a stand-alone unit, powered by a POE power supply connected to light bar 20 by a CAT5 cable via the RJ-45 connector 70.

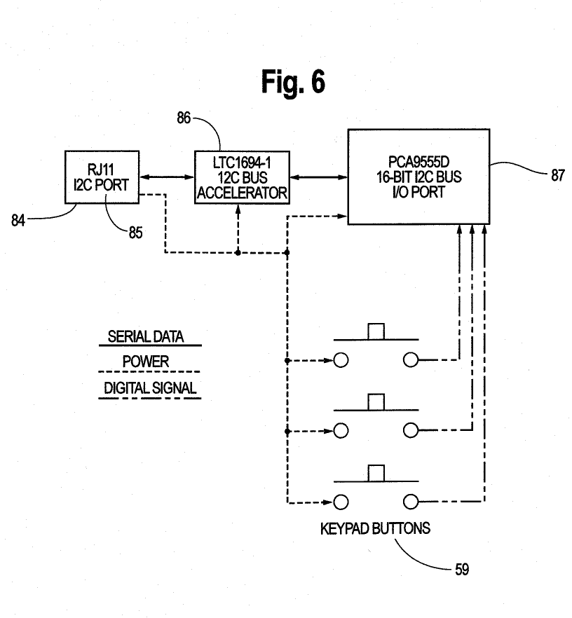

Referring now to FIG. 7, another embodiment of the present invention is shown here. System 100 may employ a single (LAN) 52 to manage patient flow, locates caregivers and personnel, and improve overall office communications. System 100 may employ a signal device, such as light bar 20 located outside examination rooms in a healthcare setting. Light bar 20 may visually display room occupancy information using color band signals 32. The visual display may be controlled using external control unit, such as a keypad 56, which has color bands 59 coordinated with color bands 32 of light bar 20 in order to enable manual control over the colors display of light bars 20. Light bar 20 may be designed to interface with LAN 52 to enable monitoring and controlling of light bars 20 from remote locations, such as a nurse's stations 55. The connection with LAN 52 may enable the status data from each light bar 20 to be stored and be available for generating reports 58.

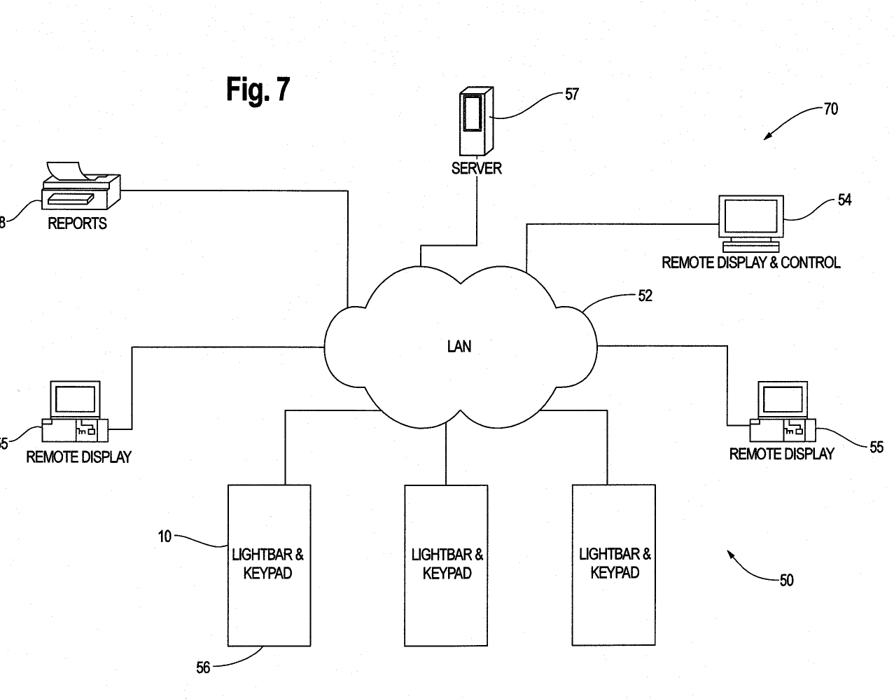

Referring now to FIG. 8, signal device 10 may be modular in that it is capable of displaying a single color band or plurality of separate color bands. Light bar 20 may include a plurality of segments 30. Each of segments 30 may display a color band 32 and each color band 32 preferably has an even tone with a clear separation of colors. In one embodiment, light bar 20 may include six segments 30 displaying six color bands 32 A-F. Light bar 20 may provide unlimited number of color choices because light bar 20 does not employ single-color LEDs. Light bar 20 is capable of being customized for a variety of applications. The number of segments 30 and the geometry of segments 30 could easily be adapted to any particular application. One of these possible applications is the use of light bar 20 in a healthcare setting in order to provide a room occupancy management system.

It will be understood that the present invention has several advantages over the prior art. Light bar 20 has all color bands 32 A-F lit with no bleeding between them. Each color band 32 is clearly separate from the other ones. Furthermore, light bar 20 may display a wide variety of color bands 32: white 32A; Green 32B; Orange 32C; Purple 32; Red 32D and Yellow 32E. Color bands 32 are capable of being operable in three states: off, on, and flashing, in order to accommodate any institution's protocol.

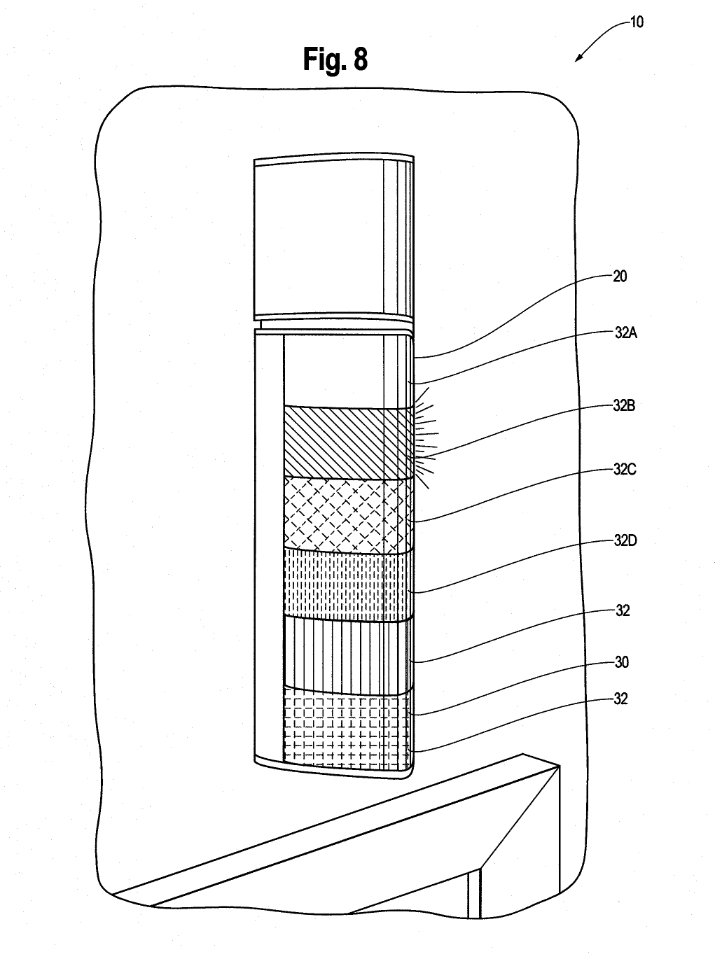

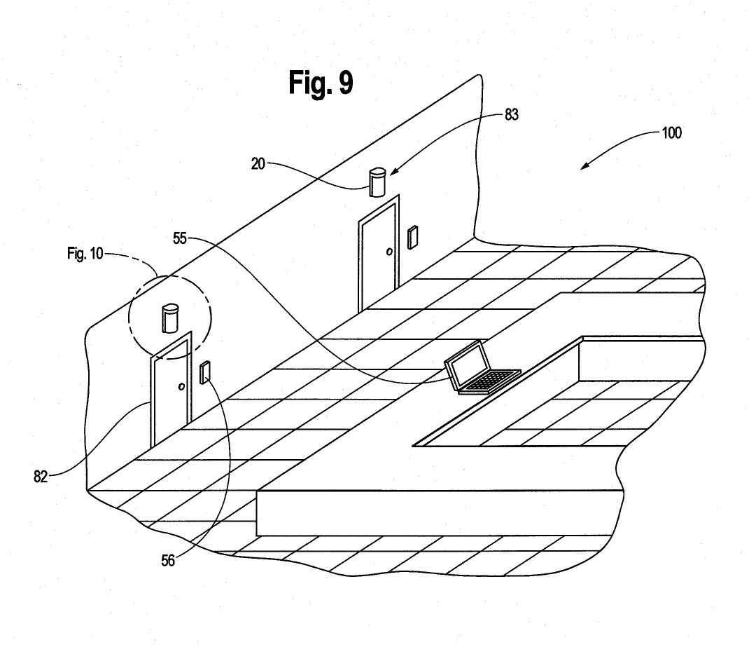

Referring now to FIG. 9, light bar 20 may be used in room occupancy management system 100 in a healthcare setting, such as a hospital. Light bar 20 may be located outside a patient room in order to show the status of a patient. Light bar 20 is capable of displaying an infinite number of colors because it employs RGB LEDs 41, shown in FIG. 10. For example, light bar 20 may be capable of displaying the color red in an emergency situation, the color white to indicate that a caregiver is currently examining the patient, the color green to indicate that the patient was examined, and so forth.

Light bar 20 may include a reader/transceiver 83 for reading radio frequency identification tags associated with caregivers and health staff. Reader/transceiver 83 may communicate with microcontroller 46 via RS232 serial data port 80 in order to change the state of the color bands of light bar 20 when the caregiver enters or leaves the room.

The reader/transceiver 83 may transmit data to a data accumulator, such as remote display and control unit 54. The data may include information about the locations of caregivers and health staff at any time. The data may enable health institution to track whether and when caregivers have examined a patient in an examination room. A radio frequency identification tag (RFID) mechanism is well known in the art. See for example, U.S. patent application Ser. No. 11/750,571 filed on May 18, 2007, which is incorporated here by reference. The mechanism typically includes a tag, a reader or transceiver, a data accumulator, and software. The tag or transponder often serves as the female button attachment for a traditional visual identification tag. The tag may be a passive responder and may be possess no power source of its own. The charge provided by the transceiver (reader) can enable the transponder to emit a signal back to the transceiver. The transponder may contain an integrated electronic circuit, the chip, and a capacitor, which captures and uses energy from the transceiver in order to send a signal back. Electronic circuits in the transponder may be programmed as Read Only (R/O). Chips may also be programmed as Read/Write, which enables information to be added, warehoused and transferred to them.

Reader/transceiver 83 may send the electronic signal to the transponder that provides the power for the transponder to send the signal back to the transceiver 83 with the information contained in the transponder's electronic circuit. Reader/transceiver 83 may be powered by batteries or plugged into a traditional power supply. Reader/transceiver 83 may be physically attached to the data accumulator, such as remote display and control unit 55, or it may transmit data to remote display and control unit 55 wirelessly. Reader/transceiver unit 83 may include a transmitter/receiver, antennae, control unit, power unit, coupling element and an electronic interface, not shown, enabling it to communicate with remote display and control unit 55.

The data accumulator, such as remote display and control unit 55, is capable of communicating with reader/transceiver 83 and accepting the information from it. The software allows the transmission of data between transponder and reader/transceiver 83, and between reader/transceiver 83 and remote display and control unit 55.

Referring to FIG. 9, the figure shows that light bar 20 may be controlled using keypad 56 mounted to a wall next to a patient's room 82 in order to allow caregivers to manually adjust the display of the colors to reflect the status of the patient in the room.

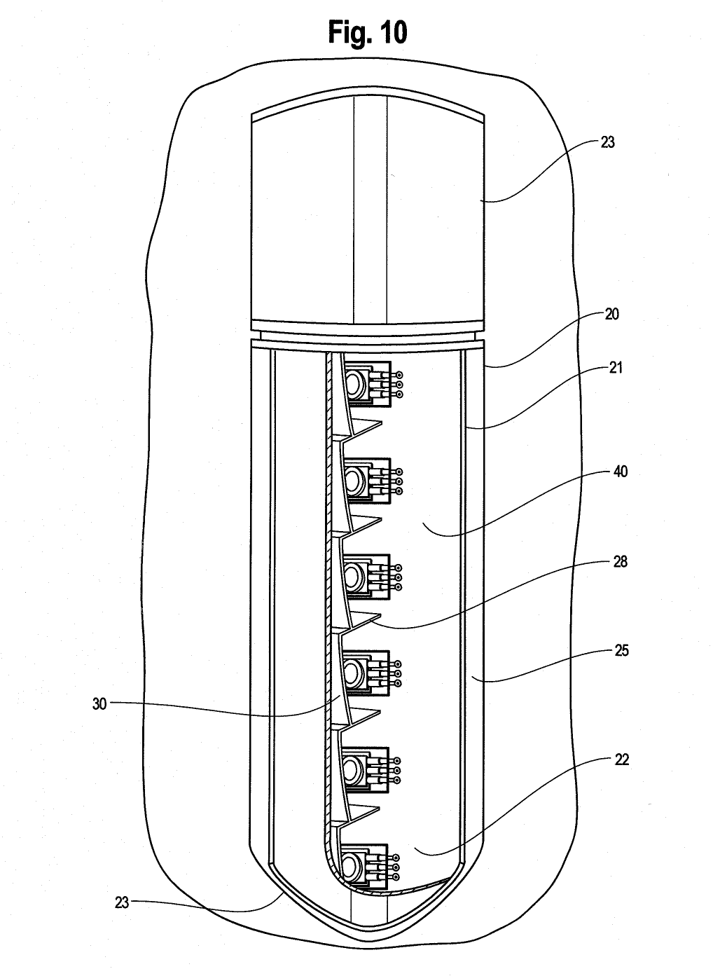

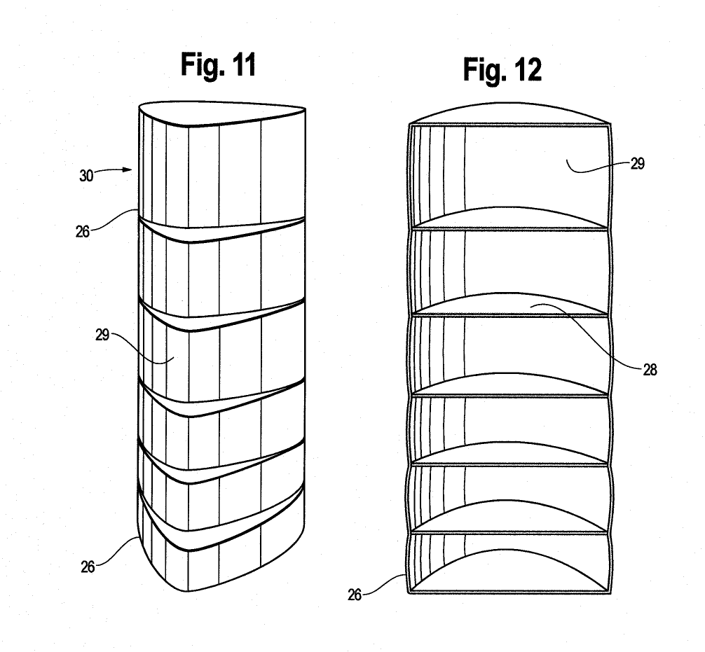

Referring now to FIGS. 10, 11 and 12, the details of light bar 20 are shown here. Light bar 20 may include a light transmissive material, such as an external elongated shell cover 22 mountable on top of a plurality of segments 30. Each segment 30 may include a light transmissive curvilinear shell 26, shown in FIGS. 11 and 12. Each shell 26 may be fastened to a base 21. Base 21 may include a track 25 for slidably receiving external cover shell 22. Referring to FIG. 10, base 21 may terminate with two terminals 23. Base 21 may be made from aluminum or any other light materials. External shell cover 22 may facilitate the presentation of substantially even color bands across each segment 30. External shell cover 22 may be made from extruded frosted acrylic plastic or any other transparent and resilient material. An opening, not shown, in the back of base 21 may be provided to allow connection of an ethernet cable to light bar 20. A data cable, not shown, may also be connected to keypad 56.

Referring to FIG. 11, a light transmissive material, such as a plurality of transmissive curvilinear shells 26, may be mountable over the top of base 21. Shells 26 may be separated by a divider 28 that substantially prevents the light from bleeding between the different color bands. Color bands bleed when they cross from one segment 30 to another. Each shell 26 preferably has a curvilinear surface 29 for spreading the light evenly inside each shell 26, creating a soft and even glow. Curvilinear surface 29 enables each color band 32 to be visible from both sides. Only one flat printed circuit board may be required for each shell 26. Shells 26 may be made from white styrene or any other similar materials.

Referring now to FIG. 12, shells 26 may have a spherical shape in order to evenly spread the light inside each shell. Each shell 26 may be separated from other shells by a divider 28 generally shaped like one-half of a circle in order to surround each shell and to prevent the light from bleeding into other shells. The shells may be constructed of any other desirable shape or geometry in order to facilitate the operation within the particular application of modular signal device 10.

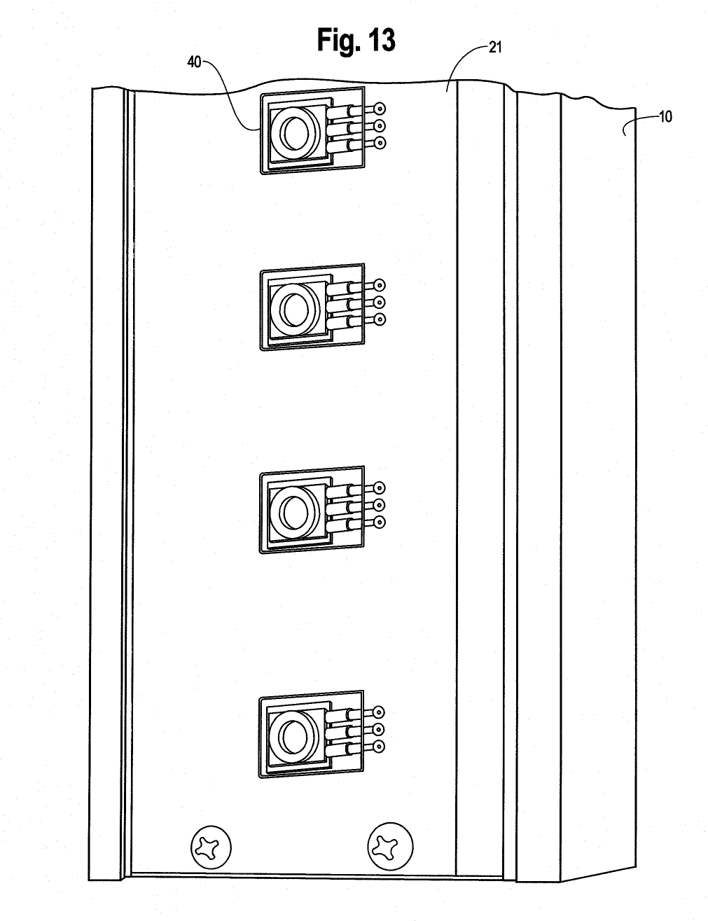

Referring now to FIG. 13, a plurality of LEDs 40, preferably red-green-blue (“RGB”) LEDs, are shown as mounted on base 21. Each segment 30 of light bar 20 may include one RGB LED, so that LEDs 40 are capable of generating an unlimited number of colors with substantially uniform brightness across segments 30.

Lack of uniform brightness causes hot spots across the light bar, which is one of the problems of the prior art. Hot spots cause confusion over the identity of color bands, and thereby frustrate the purpose of using the light bar as a signal device. Hot spots occur when different segments have different light intensity causing some segments to be more intense than others. Unlike the prior art, the present invention provides a light bar 20 with plurality of LEDs 40 having a substantially uniform brightness.

Keypad 56 is shown in FIG. 14. Keypad 56 may include a metal base 56A and a membrane keypad 56B with buttons 59 in order to control the state of color bands 32 in light bar 20. Base 56A may be designed to be mountable to a wall outside of the examination room. Base 56A may have an opening, not shown, in the back of metal base 56A in order to allow connection of a data cable to light bar 20. Keypad 56 and light bar 20 may be powered independently in the event of a network outage at server 57.

Room occupancy management system 100 may utilize standard PC workstations to remotely view and/or change room status. Host software may allow the health institution to add remote client software to the system to provide access to system 100 at other locations. In the event of a network or electrical power outage, separately powered light bar 20 and keypad 56 may be used to automatically sync and update host software residing in server 57 when the network and/or electrical power are re-established. Host software may have Open Database Connectivity (ODBC) available for data storage.

In summary, some of the advantages that system 100 provides are as follows:

1. It allows the institution to manage examination of patients efficiently.
2. It enables caregivers and health staff to monitor the status of the patients in real time.
3. It enables the institution to locate the caregivers and staff.
4. It directs the staff to the examination rooms where assistance is needed.
5. It generates patients flow reports.
6. It alerts the staff to any emergency situation.

It will be understood that various modifications to the preferred embodiment disclosed above may be made. The above description is not intended to limit the meaning of the words used in the following claims that define the invention. Rather, it is contemplated that future modifications in structure, function or result will exist that are not substantial changes and that all such insubstantial changes are intended to be covered by the following claims.

I claim:

1. A method for using at least one modular signal device for a room occupancy management system, the device comprising a light bar for displaying light patterns, wherein the light bar is divided into a plurality of segments, each segment having at least one light emitting diode (LED) for generating a color band having uniform brightness and wherein each LED is mechanically associated with the segments, the method comprising the steps of:
a. determining the status of a room; and
b. generating a signal in the at least one modular signal device in response to the determination of the status of the room.

2. The method of claim 1 further comprising the step of remotely controlling the LED by a remote display and control unit using a local area network (LAN).

3. The method of claim 1 further comprising the step of providing an external control unit having buttons coordinated with the color bands of the light bar for controlling the LEDs of the light bar.

4. The method of claim 1 further comprising the step of providing an audio signal for alerting a user of the system for particular events corresponding with a predetermined light pattern displayed on the light bar.

5. The method of claim 1, further comprising the step of providing a reader associated with the light bar for reading a radio frequency identification tag associated with located person and transmitting data to the remote display and control unit.

6. The method of claim 1 wherein each segment of the light bar further comprises a light transmissive material for diffusing and spreading the color band evenly across the material and generating an even color band in each segment, and wherein each segment is separated from other segments by a divider preventing the color of each segment from bleeding into other segments.

7. The method of claim 6 wherein the light transmissive material is a light transmissive curvilinear shell.

8. The method of claim 7 wherein the light bar further comprises a light transmissive material mountable over the curvilinear shell to facilitate the presentation of a substantially even color band across each segment.

9. The method of claim 8 wherein the light transmissive material is an extruded elongated external shell cover.

10. A room occupancy management system, comprising:
at least one modular signal device for generating a signal displaying the occupancy status of an associated room, wherein the device comprises a light bar, and wherein the light bar is divided into a plurality of segments, wherein each segment comprises a plurality of light emitting diodes (LEDs) for generating color bands; and
a control unit for controlling the at least one modular signal device.

11. The system of claim 10 wherein the control unit comprises a remote display and control unit for controlling the LEDs in real time via a LAN.

12. The system of claim 10 wherein the LEDs are adapted to be controlled by an external control unit having buttons coordinated with the color bands of the light bar for enabling control of the LEDs.

13. The system of claim 10 wherein each segment comprises a light transmissive material for diffusing and spreading the color band evenly across the material and generating an even color band in each segment, and wherein each segment being separated from other segments by a divider for preventing the color of each segment from bleeding into other segments.

14. The system of claim 10 further comprising a reader associated with the light bar for reading a radio frequency identification tag associated with a located personnel and transmitting data to the remote display and control unit.

15. A room occupancy management system in a healthcare institution, comprising:
at least one modular signal device adapted to be disposed outside a patient's room for indicating the status of examination of the patient, wherein the device comprises a light bar, and wherein the light bar is divided into a plurality of segments, wherein each segment comprises a plurality of light emitting diodes (LEDs) for generating color bands having uniform brightness, wherein the color bands indicate the status of examination of a patient; and a control unit for controlling the at least one modular signal device.

16. The system of claim 15 wherein the control unit comprises at least one remote display and control for controlling the LEDs via a LAN.

17. The system of claim 15 further including a reader associated with the light bar for reading a radio frequency identification tag associated with a caregiver and transmitting data to the remote display and control unit.

18. The system of claim 16 wherein the remote display and control units are capable of displaying data including whether a caregiver has visited a patient's examination room and the estimated waiting time of the patient in the examination room.

19. The system of claim 15 wherein the LEDs are adapted to be controlled by an external control unit having buttons coordinated with the color bands of the light bar, and wherein the external control unit is adapted to be disposed outside a patient's room and wherein the external unit is operable independently of the LAN.

20. The system of claim 15 wherein the light bar has an internet protocol (IP) address and wherein the IP address may be configured to indicate the physical location of the light bar.

21. The system of claim 20 wherein the IP address includes four octets and wherein the first octet is configured to identify the LAN that the light bar is connected to, the second octet is configured to identify the institution building floor number, the third octet is configured to identify the wing number of the floor and the fourth octet is configured to identify the patient's room number.

22. The system of claim 20 wherein the light bar has a media access control (MAC) address.

23. A room occupancy management system, comprising: at least one modular signal device for generating a signal displaying the occupancy status of an associated room, wherein the signal device has an internet protocol (IP) and a media access control (MAC) addresses; and a control unit for controlling the at least one modular signal device.

24. The system of claim 23 wherein the control unit comprises a remote display and control unit communicating with a server via a first LAN and a firmware communicating with the server via a second LAN, wherein the firmware is in communication with the signal device, wherein the firmware comprises a microcontroller chip and software permanently stored within the flash memory of the microcontroller, wherein the firmware is operatively connected to an electrically erasable programmable read-only memory (EEPROM) chip for storing the IP and MAC addresses of the signal device and retrieving the IP and MAC addresses at startup operation of the signal device.

25. The system of claim 24 wherein the firmware processes commands received from the remote display and control unit over the LANs and responds by changing a state of the signal device.

26. The system of claim 25 wherein the server periodically sends an IP data stream to the firmware to determine the state of the signal device, wherein the firmware in response checks the state of the signal device and sends an IP data stream containing the state of the signal device data back to the server, and wherein the server uses the IP data stream to update the data in the remote display and control unit.

27. The system of claim 24 further comprising a local external control unit in communication with the firmware for controlling the state of the signal device by transmitting commands to the microcontroller to change the state of the signal device, and wherein the microcontroller sends an IP data stream to the server to update the state of the signal device.

28. A method for using at least one modular signal device for a room occupancy management system, wherein the device has an internet protocol (IP) address, the method comprising the steps of:
a. determining the status of a room; and
b. generating a signal in the at least one modular signal device in response to the determination of the status of the room.

29. The method of claim 28 further comprising the step of remotely controlling the signal device by a remote display and control unit using a LAN.

30. The method of claim 29 wherein the remote display and control unit communicates with a server via a first LAN, and wherein the server communicates with a firmware of the signal device via a second LAN.

31. The method of claim 30 wherein the firmware comprises a microcontroller and software stored within the flash memory of the microcontroller.

32. The method of claim 31 wherein the firmware is operatively connected to an electrically erasable programmable read-only memory (EEPROM) chip for storing the IP address of the signal device and retrieving the IP and address at startup operation of the signal device.

33. The method of claim 32 further comprising the step of transmitting commands from the remote display and control unit to the firmware over the LANs.

34. The method of claim 33 further comprising the step of processing the commands of the remote display and control unit and changing a state of the signal device accordingly.

35. The method of claim 34 further comprising the step of periodically sending an IP data stream by the server to the firmware to determine the state of the signal device.

36. The method of claim 35 further comprising the step of checking the state of the signal device by the firmware and sending an IP data stream containing the state of the signal device data back to the server.

37. The method of claim 36 further comprising the step of processing the IP data stream by the server to update the data in the remote display and control unit.

38. The method of claim 37 further including the step of independently operating and locally controlling a state of the signal device.

39. The method of claim 38 wherein the step of independently operating and locally controlling the signal device includes the step of transmitting commands to the microcontroller to change a state of the signal device.

40. The method of claim 39 further including the step of transmitting an IP data stream back to the server to update the state of the signal device.
